(19) United States
(12) Patent Application Publication
(10) Pub. No.: US 2026/0265460 A1
(43) Pub. Date: Sep. 10, 2026

(54) METHOD FOR PREPARING POLYSULFONE RESIN THROUGH SEGMENTED POLYMERIZATION

(71) Applicant: SHANDONG HORAN SPECIAL PLASTICS CO ., LTD, Weihai, Shandong (CN)

(72) Inventors: Guodong DANG, Weihai, Shandong (CN); Bo SUN, Weihai, Shandong (CN); Haiqiu SUN, Weihai, Shandong (CN); Hui LI, Weihai, Shandong (CN); Shijun YIN, Weihai, Shandong (CN)

(73) Assignee: SHANDONG HORAN SPECIAL PLASTICS CO ., LTD, Weihai, Shandong (CN)

(21) Appl. No.: 19/154,736

(22) PCT Filed: Mar. 11, 2024
(86) PCT No.: PCT/CN2024/080885

§ 371 Date: Aug. 7, 2025

(30) Foreign Application Priority Data
Nov. 15, 2023 (CN) 202311526518.4

(51) Int. Cl. C08G 75/20; C08G 85/00; C08K 3/26; C08K 5/13; C08K 5/41

(52) U.S. Cl. CPC C08G 75/20; C08G 85/002; C08K 3/26; C08K 5/13; C08K 5/41; C08K 2003/262

(57) ABSTRACT

Provided is a method for preparing a polysulfone resin through segmented polymerization. The method includes: mixing a first halogenated monomer, a first phenolic monomer, a first alkali metal-containing substance, and a first solvent, and subjecting a resulting mixture to a first prepolymerization reaction to obtain a first prepolymer system; mixing a second halogenated monomer, a second phenolic monomer, a second alkali metal-containing substance, and a second solvent, and subjecting a resulting mixed material to a second prepolymerization reaction to obtain a second prepolymer system, wherein a molar ratio of the second halogenated monomer to the second phenolic monomer is in a range of 3:3.3 to 3:6, and the second halogenated monomer comprises a sulfonyl group; and subjecting the first prepolymer system and the second prepolymer system to salt removal and then a polymerization reaction to obtain the polysulfone resin.

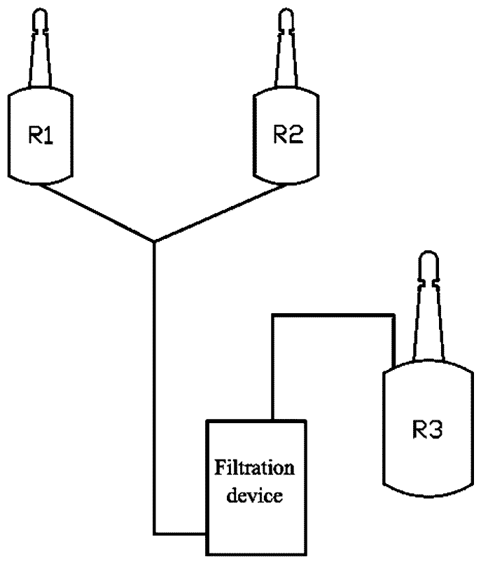

### CROSS REFERENCE TO RELATED APPLICATION

This patent application is a national stage application of International Patent Application No. PCT/CN2024/080885, filed on Mar. 11, 2024, which claims the benefit and priority of Chinese Patent Application No. CN202311526518.4 filed with the China National Intellectual Property Administration on Nov. 15, 2023 and entitled “METHOD FOR PREPARING POLYSULFONE RESIN THROUGH SEGMENTED POLYMERIZATION”. The disclosure of the two applications is incorporated by reference in its entirety.

### TECHNICAL FIELD

The present disclosure belongs to the technical field of preparation of polymer materials, and specifically relates to a method for preparing a polysulfone resin through segmented polymerization.

### BACKGROUND

Currently, the most advanced production process for polysulfone polymer materials is the one-step synthesis process: 4,4′-dichlorodiphenyl sulfone (DCDPS) (a halogenated monomer), a phenolic polymerization monomer, and an alkali metal salt (such as potassium carbonate) as the main raw materials are subjected to polymerization in a solvent. The solvent commonly includes dimethyl sulfoxide (DMSO), N,N-dimethylformamide (DMF), N,N-dimethylacetamide (DMAC), N-methylpyrrolidone, etc. After the polymerization is completed, water, ethanol, or methanol is used as a precipitating agent to separate a polysulfone from a polymer solution through precipitation. A resulting separated polysulfone is then purified, dried, granulated, and packaged to produce a polysulfone product. However, in the one-step synthesis process for producing polysulfone resins, a polysulfone resin produced after the polymerization is a high-molecular-weight polymer with high viscosity, and thus it is difficult to effectively remove salts and low-molecular-weight polymers trapped in the high-molecular-weight polymer, which compromises the quality of a polysulfone resin product. Additionally, due to the presence of salts, a polymerization system is a heterogeneous phase, which interferes with the intermolecular collision frequency during a stirring process for polymerization to affect a reaction rate. As a result, the one-step synthesis process cannot lead to ultra-high-molecular-weight polysulfone products.

### SUMMARY

In view of this, an object of the present disclosure is to provide a method for preparing a polysulfone resin through segmented polymerization. The polysulfone resin prepared through segmented polymerization in the present disclosure includes few salts and low-molecular-weight polymers, and exhibits a low haze value. The segmented polymerization of the present disclosure can lead to an ultra-high-molecular-weight polysulfone product.

To achieve the object of the present disclosure, the present disclosure provides the following technical solutions:

The present disclosure provides a method for preparing a polysulfone resin through segmented polymerization, including the following steps:
mixing a first halogenated monomer, a first phenolic monomer, a first alkali metal-containing substance, and a first solvent, and subjecting a resulting mixture to a first prepolymerization reaction to obtain a first prepolymer system, where a molar ratio of the first halogenated monomer to the first phenolic monomer is in a range of (3.3-6):3; and the first halogenated monomer includes a sulfonyl group;
mixing a second halogenated monomer, a second phenolic monomer, a second alkali metal-containing substance, and a second solvent, and subjecting a resulting mixed material to a second prepolymerization reaction to obtain a second prepolymer system, where a molar ratio of the second halogenated monomer to the second phenolic monomer is in a range of 3:(3.3-6); and the second halogenated monomer includes a sulfonyl group; and
subjecting the first prepolymer system and the second prepolymer system to salt removal and then a polymerization reaction to obtain the polysulfone resin.

In some embodiments, the first halogenated monomer and the second halogenated monomer each independently include DCDPS and/or 4,4′-difluorodiphenyl sulfone (DFDPS).

In some embodiments, the first phenolic monomer and the second phenolic monomer each independently include at least one selected from the group consisting of bisphenol A, bisphenol S, and 4,4′-biphenol.

In some embodiments, the molar ratio of the first halogenated monomer to the first phenolic monomer is in a range of (3.8-5.3):3, and the molar ratio of the second halogenated monomer to the second phenolic monomer is in a range of 3:(3.8-5.3).

In some embodiments, a molar ratio of a total amount of the first halogenated monomer and the second halogenated monomer to a total amount of the first phenolic monomer and the second phenolic monomer is in a range of (1-1.05):(1-1.05).

In some embodiments, the first alkali metal-containing substance and the second alkali metal-containing substance each independently include an alkali metal hydroxide and/or an alkali metal salt.

In some embodiments, a molar ratio of the first alkali metal-containing substance to the first halogenated monomer and a molar ratio of the second alkali metal-containing substance to the second phenolic monomer each are independently in a range of (1.01-1.51):1.

In some embodiments, the first prepolymerization reaction and the second prepolymerization reaction each are conducted independently at a temperature of 180° C. to 200° C. independently for 2 h to 3 h.

In some embodiments, the polymerization reaction is conducted at a temperature of 220° C. to 250° C. for 2 h to 8 h.

In some embodiments, the polymerization reaction is conducted at the temperature of 230° C. to 250° C. for 4 h to 8 h.

The present disclosure also provides an apparatus for preparing a polysulfone resin through segmented polymerization, including a first polymerization reactor, a second polymerization reactor connected in parallel with the first polymerization reactor, a filtration device communicating with discharge ports of the first polymerization reactor and the second polymerization reactor, and a third polymerization reactor communicating with a discharge port of the filtration device.

Compared with the prior art, some embodiments of the present disclosure have the following beneficial effects:

In the method for preparing a polysulfone resin through segmented polymerization provided by the present disclosure, a polymerization process is divided into a prepolymerization reaction (including a first prepolymerization reaction and a second prepolymerization reaction) and a polymerization reaction after salt removal. For the prepolymerization reaction, a mode with an excess of a phenolic monomer added and a mode with an excess of a halogenated monomer added are adopted. By controlling the excess degrees of the phenolic monomer and the halogenated monomer, the increase in a viscosity of a resulting prepolymer system (including a first prepolymer system and a second prepolymer system) can be controlled. After a salt-forming reaction of a phenolic monomer and a halogenated monomer is completed at a prepolymerization stage, salt removal is conducted, and in this case, a viscosity of the polymerization system is relatively low. At a temperature of 200° C. and a viscosity of 5 mPa·s to 20 mPa·s, salts in the prepolymer can be easily separated. After the salt removal is conducted at this stage, the overall salt removal effect is greatly improved. As a result, the method in the present disclosure solves the problem that it is difficult to effectively remove salts and low-molecular-weight polymers trapped in a high-molecular-weight polymer produced after polymerization due to high viscosity (700 mPa·s to 1,200 mPa·s) in the one-step synthesis process for producing polysulfone resins, and can improve the quality of the polysulfone resin.

Further, after the prepolymer system (including the first prepolymer system and the second prepolymer system) of the present disclosure is subjected to salt removal, the resulting polymerization system is nearly homogeneous, which allows a high intermolecular collision frequency and can significantly enhance the reaction rate. Furthermore, by controlling the temperature and time for the polymerization reaction, the controlled polymerization of an ultra-high-molecular-weight polymer can be achieved without causing a crosslinking-induced runaway polymerization phenomenon.

### BRIEF DESCRIPTION OF THE DRAWING

To describe the technical solutions in the embodiments of the present disclosure or in the prior art clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without inventive efforts.

FIGURE shows a schematic diagram of the apparatus for preparing a polysulfone resin through segmented polymerization in Example 1.

### DETAILED DESCRIPTION OF THE EMBODIMENTS

The present disclosure provides a method for preparing a polysulfone resin through segmented polymerization, including the following steps:
mixing a first halogenated monomer, a first phenolic monomer, a first alkali metal-containing substance, and a first solvent are mixed, and subjecting a resulting mixture to a first prepolymerization reaction to obtain a first prepolymer system, where a molar ratio of the first halogenated monomer to the first phenolic monomer is in a range of (3.3-6):3, and the first halogenated monomer includes a sulfonyl group;
mixing a second halogenated monomer, a second phenolic monomer, a second alkali metal-containing substance, and a second solvent and subjecting a resulting mixed material to a second prepolymerization reaction to obtain a second prepolymer system, where a molar ratio of the second halogenated monomer to the second phenolic monomer is in a range of 3:(3.3-6), and the second halogenated monomer includes a sulfonyl group; and
subjecting the first prepolymer system and the second prepolymer system to salt removal and then a polymerization reaction to obtain the polysulfone resin.

In the present disclosure, unless otherwise specified, all materials and devices used are commercially-available products in the art.

In the present disclosure, a first halogenated monomer, a first phenolic monomer, a first alkali metal-containing substance, and a first solvent are mixed, and a resulting mixture is subjected to a first prepolymerization reaction to obtain a first prepolymer system. A molar ratio of the first halogenated monomer to the first phenolic monomer is in a range of (3.3-6):3.

In the present disclosure, a second halogenated monomer, a second phenolic monomer, a second alkali metal-containing substance, and a second solvent are mixed, and a resulting mixed material is subjected to a second prepolymerization reaction to obtain a second prepolymer system. A molar ratio of the second halogenated monomer to the second phenolic monomer is in a range of 3:(3.3-6).

In some embodiments of the present disclosure, the first halogenated monomer and the second halogenated monomer are both an aromatic dihalosulfone monomer, and the aromatic dihalosulfone monomer preferably includes DCDPS and/or DFDPS. In some embodiments, the first halogenated monomer and the second halogenated monomer both are DCDPS.

In some embodiments of the present disclosure, the first phenolic monomer and the second phenolic monomer are both an aromatic dihydroxy monomer, and the aromatic dihydroxy monomer preferably includes at least one selected from the group consisting of bisphenol A, bisphenol S, and 4,4′-biphenol. In some embodiments, the first halogenated monomer and the second halogenated monomer are both 4,4′-biphenol.

In some embodiments of the present disclosure, the molar ratio of the first halogenated monomer to the first phenolic monomer is in a range of (3.8-5.3):3 and more preferably 4:3, and the molar ratio of the second halogenated monomer to the second phenolic monomer is in a range of 3:(3.8-5.3) and more preferably 3:4. In the present disclosure, an excess degree of one of the monomers in a prepolymerization reaction (including the first prepolymerization reaction and the second prepolymerization reaction) can be controlled to control the increase in a viscosity of a prepolymer system (including the first prepolymer and the second prepolymer), thereby facilitating the subsequent salt removal.

In some embodiments of the present disclosure, a molar ratio of a total amount of the first halogenated monomer and the second halogenated monomer to a total amount of the first phenolic monomer and the second phenolic monomer is in a range of (1-1.05):(1-1.05) and more preferably (1-1.03):1.

In some embodiments of the present disclosure, the first alkali metal-containing substance and the second alkali metal-containing substance each independently include an alkali metal hydroxide and/or an alkali metal salt. In some embodiments, the alkali metal hydroxide includes sodium hydroxide and/or potassium hydroxide. In some embodiments, the alkali metal salt includes at least one selected from the group consisting of sodium carbonate, potassium carbonate, potassium bicarbonate, sodium bicarbonate, and sodium hydride.

In some embodiments of the present disclosure, a molar ratio of the first alkali metal-containing substance to the first halogenated monomer and a molar ratio of the second alkali metal-containing substance to the second phenolic monomer each are independently in a range of (1.01-1.51):1 and more preferably 1.1:1.

In some embodiments of the disclosure, the first solvent and the second solvent are both an aprotic polar solvent. In some embodiments, the aprotic polar solvent includes at least one selected from the group consisting of DMSO, dimethyl sulfone, diphenyl sulfone (DPS), diethyl sulfoxide, sulfolane, tetrahydrothiophene-1-oxide, DMAC, DMF, N-methyl-2-pyrrolidone (NMP), and 1,3-dimethyl-2-imidazolidinone (DMI).

In some embodiments of the present disclosure, the first prepolymerization reaction and the second prepolymerization reaction each are conducted independently at a temperature of 180° C. to 200° C. and more preferably 190° C. independently for 2 h to 3 h. During the first prepolymerization reaction and the second prepolymerization reaction, a hydroxyl terminal group in a phenolic monomer reacts with an alkali metal-containing substance (such as sodium carbonate) in an alkaline environment to produce an alkali metal salt terminal group, and then the alkali metal salt terminal group in the phenolic monomer attacks a halogen element in a halogenated monomer at a high temperature to produce a preliminary basic chain segment for a polymer, during which an alkali metal and the halogen element react to produce a halogenated alkali metal salt to fall off.

In the present disclosure, a terminal group of a prepolymer in the first prepolymer system is a halogen element, and a terminal group of a prepolymer in the second prepolymer system is a phenolate terminal group. In some embodiments, the first prepolymer system and the second prepolymer system both have a viscosity of 5 mPa·s to 20 mPa·s.

In the present disclosure, after the first prepolymer system and the second prepolymer system are obtained, the first prepolymer system and the second prepolymer system are subjected to salt removal and then a polymerization reaction to obtain the polysulfone resin.

In some embodiments of the present disclosure, the salt removal is conducted by hot filtration. In some embodiments, the hot filtration is conducted at a temperature of 160° C. to 190° C. In some embodiments, a device for the hot filtration is a titanium rod filter. In some embodiments of the present disclosure, the salt removal is conducted through hot filtration. Within the temperature range specified for the hot filtration in some embodiments of the present disclosure, a polymer produced from a prepolymerization reaction exhibits excellent solubility, and halogenated alkali metal salts can be completely removed.

In some embodiments of the present disclosure, the first prepolymer system and the second prepolymer system are first mixed and then subjected to salt removal. In some embodiments, the method further includes, after the salt removal, adding an end-capping reagent to a resulting system. In some embodiments, the end-capping reagent includes a halogenated monomer and/or a phenolic monomer. In some embodiments, the halogenated monomer is of the same type as the first halogenated monomer or the second halogenated monomer, and the phenolic monomer is of the same type as the first phenolic monomer or the second phenolic monomer, which will not be repeated here. In some embodiments, an amount of the end-capping reagent is 1% of a total molar amount of the first halogenated monomer and the second halogenated monomer or 2% of a total molar amount of the first phenolic monomer and the second phenolic monomer.

In some embodiments of the present disclosure, the polymerization reaction is conducted at a temperature of 220° C. to 250° C., more preferably 230° C. to 250° C., and further more preferably 240° C., and the polymerization reaction is conducted for 2 h to 8 h, more preferably 4 h to 8 h, and further more preferably 6 h.

In some embodiments of the present disclosure, a polymer mixed solution is obtained after the polymerization reaction. In some embodiments, the method further includes: after the polymer mixed solution is obtained, subjecting a resulting polymer mixed solution to discharging and dispersing, crushing, washing, and drying in sequence to obtain the polysulfone resin.

In the present disclosure, there are no special requirements for processes of discharging and dispersing and crushing, and the processes well known to those skilled in the art may be adopted. In some embodiments, a reagent adopted for the discharging and dispersing is water, and during the discharging and dispersing, the polysulfone resin is precipitated in the water.

In some embodiments of the present disclosure, a reagent adopted for the washing is pure water, and a water-to-material mass ratio for the washing is 8:1. In some embodiments, the washing is conducted 8 times. In some embodiments, the washing may remove salts.

In some embodiments of the present disclosure, the drying is conducted at a temperature of 150° C. to 170° C. and more preferably 160° C., and the drying is conducted for 6 h to 8 h and more preferably 7 h.

The present disclosure also provides an apparatus for preparing a polysulfone resin through segmented polymerization, including a first polymerization reactor, a second polymerization reactor connected in parallel with the first polymerization reactor, a filtration device communicating with discharge ports of the first polymerization reactor and the second polymerization reactor, and a third polymerization reactor communicating with a discharge port of the filtration device.

FIGURE is a schematic diagram of the apparatus for preparing a polysulfone resin through segmented polymerization in an embodiment of the present disclosure. The apparatus includes the first polymerization reactor R1, the second polymerization reactor R2 connected in parallel with the first polymerization reactor R1, the filtration device communicating with the discharge ports of the first polymerization reactor R1 and the second polymerization reactor R2, and the third polymerization reactor R3 communicating with the discharge port of the filtration device. In some embodiments, a process for preparing a polysulfone resin by using the apparatus includes: conducting preliminary polymerization reactions (prepolymerization reactions) in the polymerization reactors R1 and R2, respectively, then conducting salt removal through the filtration device, and then subjecting a product from the salt removal to a high-temperature (220° C. to 250° C.) polymerization reaction in the polymerization reactor R3 to obtain the polysulfone resin.

In order to further illustrate the present disclosure, the method for preparing a polysulfone resin through segmented polymerization in the present disclosure is described in detail below in connection with the accompanying drawing and examples, but the scope of the present disclosure is not limited thereto.

### Example 1

Segmented polymerization was conducted with DCDPS and 4,4′-biphenol as raw materials:

Preliminary polymerization of DCDPS and 4,4′-biphenol at a molar ratio of 4:3 in a polymerization reactor R1: 11.486 kg of DCDPS, 5.61 kg of 4,4′-biphenol, and 4.7 kg of sodium carbonate were added to the polymerization reactor R1, and 44.73 kg of sulfolane was added thereto as a solvent.

Preliminary polymerization of DCDPS and 4,4′-biphenol at a molar ratio of 3:4 in a polymerization reactor R2: 8.615 kg of DCDPS, 7.48 kg of 4,4′-biphenol, and 4.7 kg of sodium carbonate were added to the polymerization reactor R2, and 41.73 kg of sulfolane was added thereto as a solvent.

The preliminary polymerization in each of the polymerization reactors R1 and R2 was conducted at 180° C. for 3 h to complete a salt-forming reaction. Preliminary polymerization products from the polymerization reactors R1 and R2 were subjected to salt removal through a filtration device and then mixed in a polymerization reactor R3 and subjected to a high-temperature polymerization reaction. DCDPS was added at a molar amount of 1% (which was calculated based on a total amount of DCDPS in the polymerization reactors R1 and R2) to the polymerization reactor R3 for end-capping. A polymerization was conducted for 5 h at 220° C. under stirring. An entire polymerization process was conducted under protection of an inert gas (nitrogen). A polymer mixed solution obtained after the polymerization was discharged and dispersed, crushed, washed (washing was conducted 8 times with ultrapure water, and a water-to-material mass ratio was 8:1), and oven-dried to obtain a polyphenylsulfone resin powder as a finished product.

The polysulfone product obtained in Example 1 has a haze of 1.1 and a low-molecular-weight polymer content of 40 ppm.

### Example 2

Segmented polymerization was conducted with DCDPS and 4,4′-dihydroxydiphenyl sulfone as raw materials:

Preliminary polymerization of DCDPS and 4,4′-dihydroxydiphenyl sulfone at a molar ratio of 4:3 in a polymerization reactor R1: 11.486 kg of DCDPS, 7.5 kg of 4,4′-dihydroxydiphenyl sulfone, and 4.7 kg of sodium carbonate were added to the polymerization reactor R1, and 50.388 kg of sulfolane was added thereto as a solvent.

Preliminary polymerization of DCDPS and 4,4′-dihydroxydiphenyl sulfone at a molar ratio of 3:4 in a polymerization reactor R2: 8.615 kg of DCDPS, 10 kg of 4,4′-dihydroxydiphenyl sulfone, and 4.7 kg of sodium carbonate were added to the polymerization reactor R2, and 49.275 kg of sulfolane was added thereto as a solvent.

The preliminary polymerization in each of the polymerization reactors R1 and R2 was conducted at 180° C. for 3 h to complete a salt-forming reaction. Preliminary polymerization products from the polymerization reactors R1 and R2 were subjected to salt removal through a filtration device and then mixed in a polymerization reactor R3 and subjected to a high-temperature polymerization reaction. 4,4′-dihydroxydiphenyl sulfone was added at a molar amount of 2% (which was calculated based on a total amount of 4,4′-dihydroxydiphenyl sulfone in the polymerization reactors R1 and R2) to the polymerization reactor R3 for end-capping. A polymerization was conducted for 5 h at 220° C. under stirring. An entire polymerization process was conducted under protection of an inert gas (nitrogen). A polymer mixed solution obtained after the polymerization was discharged and dispersed, crushed, washed (washing was conducted 8 times with ultrapure water, and a water-to-material mass ratio was 8:1), and oven-dried to obtain a polyphenylsulfone resin powder as a finished product.

The polysulfone product obtained in Example 2 has a haze of 1.5 and a low-molecular-weight polymer content of 50 ppm.

### Example 3

Segmented polymerization was conducted with DCDPS and 4,4′-dihydroxydiphenyl sulfone as raw materials to prepare an ultra-high-molecular-weight polymer. A polymerization reaction was conducted with a solid content of 35%.

Preliminary polymerization of DCDPS and 4,4′-dihydroxydiphenyl sulfone at a molar ratio of 4:3 in a polymerization reactor R1: 11.486 kg of DCDPS, 7.504 kg of 4,4′-dihydroxydiphenyl sulfone, and 7.4 kg of sodium carbonate were added to the polymerization reactor R1, and 31.2 kg of sulfolane was added thereto as a solvent.

Preliminary polymerization of DCDPS and 4,4′-dihydroxydiphenyl sulfone at a molar ratio of 3:4 in a polymerization reactor R2: 8.615 kg of DCDPS, 10.048 kg of 4,4′-dihydroxydiphenyl sulfone, and 7.4 kg of sodium carbonate were added to the polymerization reactor R2, and 30.59 kg of sulfolane was added thereto as a solvent.

The preliminary polymerization in each of the polymerization reactors R1 and R2 was conducted at 180° C. for 3 h with a solid content of 35% to complete a salt-forming reaction. Preliminary polymerization products from the polymerization reactors R1 and R2 were subjected to salt removal through a filtration device and then mixed in a polymerization reactor R3 and subjected to a high-temperature polymerization reaction. In the polymerization reactor R3, polymerization was conducted for 6 h at 240° C. under stirring. An entire polymerization process was conducted under protection of an inert gas (nitrogen). A polymer mixed solution obtained after the polymerization was discharged and dispersed, crushed, washed (washing was conducted 8 times with ultrapure water, and a water-to-material mass ratio was 8:1), and oven-dried to obtain a polyphenylsulfone resin powder as a finished product.

The polysulfone product obtained in Example 3 has a weight-average molecular weight of 800000.

### Comparative Example 1

One-step polymerization was conducted with DCDPS and 4,4′-biphenol as raw materials:

Polymerization of DCDPS and 4,4′-biphenol at a molar ratio of 1.03:1 in a polymerization reactor: 11.83 kg of DCDPS, 7.46 kg of 4,4′-biphenol, and 6.3 kg of sodium carbonate were added to the polymerization reactor, and 14.5 kg of sulfolane was added thereto as a solvent. A salt-forming polymerization reaction was conducted at 180° C. for 3 h, and then a polymerization reaction was conducted for 5 h at 220° C. under stirring. An entire polymerization process was conducted under protection of an inert gas (nitrogen). A polymer mixed solution obtained after the polymerization reaction was discharged and dispersed, crushed, washed (washing was conducted 8 times with ultrapure water, and a water-to-material mass ratio was 8:1), and oven-dried to obtain a polyphenylsulfone resin powder as a finished product.

The polysulfone product obtained in Comparative Example 1 has a haze of 5 and a low-molecular-weight polymer content of 1,000 ppm.

According to the data of the examples and comparative example, the polysulfone resin product prepared through segmented polymerization in the present disclosure exhibits a haze significantly reduced, a low-molecular-weight polymer content remarkably decreased, and a quality significantly improved. Furthermore, the present disclosure can prepare an ultra-high-molecular-weight (800,000) polysulfone product by further controlling a solid content of a material solution and temperature and time for a polymerization reaction during a polymerization process.

Although the present disclosure has been described in detail through the above examples, the examples are merely some rather than all of the examples of the present application. All other examples obtained by a person based on these examples without inventive efforts shall fall within the scope of the present application.

What is claimed is:

1. A method for preparing a polysulfone resin through segmented polymerization, comprising the following steps:
mixing a first halogenated monomer, a first phenolic monomer, a first alkali metal-containing substance, and a first solvent, and subjecting a resulting mixture to a first prepolymerization reaction to obtain a first prepolymer system, wherein a molar ratio of the first halogenated monomer to the first phenolic monomer is in a range of 3.3:3 to 6:3, and the first halogenated monomer comprises a sulfonyl group;
mixing a second halogenated monomer, a second phenolic monomer, a second alkali metal-containing substance, and a second solvent, and subjecting a resulting mixed material to a second prepolymerization reaction to obtain a second prepolymer system, wherein a molar ratio of the second halogenated monomer to the second phenolic monomer is in a range of 3:3.3 to 3:6, and the second halogenated monomer comprises a sulfonyl group; and
subjecting the first prepolymer system and the second prepolymer system to salt removal and then a polymerization reaction to obtain the polysulfone resin.

2. The method for preparing the polysulfone resin through the segmented polymerization of claim 1, wherein the first halogenated monomer and the second halogenated monomer each independently comprise at least one selected from the group consisting of 4,4′-dichlorodiphenyl sulfone (DCDPS) and 4,4′-difluorodiphenyl sulfone (DFDPS).

3. The method for preparing the polysulfone resin through the segmented polymerization of claim 1, wherein the first phenolic monomer and the second phenolic monomer each independently comprise at least one selected from the group consisting of bisphenol A, bisphenol S, and 4,4′-biphenol.

4. The method for preparing the polysulfone resin through the segmented polymerization of claim 1, wherein the molar ratio of the first halogenated monomer to the first phenolic monomer is in a range of 3.8:3 to 5.3:3, and the molar ratio of the second halogenated monomer to the second phenolic monomer is in a range of 3:3.8 to 3:5.3.

5. The method for preparing the polysulfone resin through the segmented polymerization of claim 4, wherein the molar ratio of the first halogenated monomer to the first phenolic monomer is 4:3, and the molar ratio of the second halogenated monomer to the second phenolic monomer is 3:4.

6. The method for preparing the polysulfone resin through the segmented polymerization of claim 1, wherein a molar ratio of a total amount of the first halogenated monomer and the second halogenated monomer to a total amount of the first phenolic monomer and the second phenolic monomer is in a range of 1-1.05:1-1.05.

7. The method for preparing the polysulfone resin through the segmented polymerization of claim 1, wherein the first alkali metal-containing substance and the second alkali metal-containing substance each independently comprise at least one selected from the group consisting of an alkali metal hydroxide and an alkali metal salt.

8. The method for preparing the polysulfone resin through the segmented polymerization of claim 1, wherein a molar ratio of the first alkali metal-containing substance to the first halogenated monomer and a molar ratio of the second alkali metal-containing substance to the second phenolic monomer each are independently in a range of 1.01:1 to 1.51:1.

9. The method for preparing the polysulfone resin through the segmented polymerization of claim 1, wherein the first prepolymerization reaction and the second prepolymerization reaction each are conducted independently at a temperature of 180° C. to 200° C. independently for 2 hours to 3 hours.

10. The method for preparing the polysulfone resin through the segmented polymerization according to claim 1, wherein the method further comprises after the salt removal, adding an end-capping reagent.

11. The method for preparing the polysulfone resin through the segmented polymerization of claim 1, wherein the polymerization reaction is conducted at a temperature of 220° C. to 250° C. for 2 hours to 8 hours.

12. The method for preparing the polysulfone resin through the segmented polymerization of claim 11, wherein the polymerization reaction is conducted at the temperature of 230° C. to 250° C. for 4 hours to 8 hours.

13. The method for preparing the polysulfone resin through the segmented polymerization of claim 1, wherein the method further comprises: after the polymerization reaction is completed, subjecting a polymer mixed solution obtained after the polymerization reaction to discharging and dispersing, crushing, washing, and drying in sequence to obtain the poly sulfone resin.

14. An apparatus for preparing a polysulfone resin through segmented polymerization, comprising a first polymerization reactor, a second polymerization reactor connected in parallel with the first polymerization reactor, a filtration device communicating with discharge ports of the first polymerization reactor and the second polymerization reactor, and a third polymerization reactor communicating with a discharge port of the filtration device.

15. The method for preparing the polysulfone resin through the segmented polymerization of claim 4, wherein a molar ratio of a total amount of the first halogenated monomer and the second halogenated monomer to a total amount of the first phenolic monomer and the second phenolic monomer is in a range of 1-1.05:1-1.05.

16. The method for preparing the polysulfone resin through the segmented polymerization of claim 7, wherein a molar ratio of the first alkali metal-containing substance to the first halogenated monomer and a molar ratio of the second alkali metal-containing substance to the second phenolic monomer each are independently in a range of 1.01:1 to 1.51:1.
